(19) United States
(12) Patent Application Publication
(10) Pub. No.: US 2009/0022493 A1
(43) Pub. Date: Jan. 22, 2009

(54) PON equipment capablel of displaying connection state and logical link identifier

(75) Inventor: Kevin Lu, Taipei (TW)

Correspondence Address: BACON & THOMAS, PLLC, 625 SLATERS LANE, FOURTH FLOOR, ALEXANDRIA, VA, 22314-1176, US

(73) Assignee: Inventec Multimedia & Telecom (Tianjin) Co., Ltd., Tianjin (CN)

(21) Appl. No.: 11/826,601

(22) Filed: Jul. 17, 2007

(51) Int. Cl. H04B 10/20

(52) U.S. Cl. 398/58

(57) ABSTRACT

A passive optical network (PON) equipment capable of displaying a connection state and a logical link identifier (LLID) is provided, which aims at solving a problem that equipments in the conventional PON system cannot display connection state and LLID. The PON equipment displays the connection state and the LLID through a programmable logic element and a display unit by utilizing characteristics of multi-point control protocol (MPCP) and LLID, so as to achieve the efficacy of displaying the connection state and the LLID.

### BACKGROUND OF THE INVENTION

1. Field of Invention

The present invention relates to a passive optical network (PON) equipment capable of displaying a connection state and a logical link identifier (LLID). More particularly, the present invention relates to a PON equipment capable of displaying the connection state and a LLID through a programmable logic element and a display unit by means of utilizing the characteristics of multi-point control protocol (MPCP) and LLID.

2. Related Art

As the rapid development of Internet, the conventional network cannot meet the requirements of high speed transmission application. However, as the mature of the optoelectronics industry and the diversification of product applications, a wide bandwidth is provided for the rapidly developed Internet. Compared with the conventional cable transmission mode, the optical fiber transmission has the characteristics of a large capacity, a low consumption, and anti-electromagnetic interference capability. Therefore, as the cost of the optical fiber transmission gradually decreases, the optical fiber communication is an inevitable developing trend, and broadband network (FTTx) technologies mainly using the optical fiber are emerged one after another. The FTTx technology is mainly used to make the access network be achieved through optical fibers in a wide range from the central office equipment of a local telecommunication facility to customer premise equipments. The essential central office equipment includes an optical line terminal (OLT); and the customer premise equipment is an optical network unit (ONU), or an optical network terminal (ONT).

The optical topology mainly includes two forms. The first one is a direct optical connection, which belongs to a topology in a point to point (P2P) manner, and has the characteristics of simple operations, easy management, and exclusive optical bandwidth. However, since a large amount of the optical fiber is required, the cost is high. The other one is a PON technology with the entity topology map shown in FIG. 1, which belongs to a topology in a point to multi-point (P2MP) manner, in which an optical splitter 101 is used to split the optical path from the OLT 100 to transmit to the ONU 102 at the customer premise. Since a small number of the optical fiber is required, the cost for establishment and maintenance is saved. Therefore, the PON technology is highly evaluated in the optical topology.

In the current PON market, on the OLT at the central office, the messages about the connection state and the identification of the ONU are acquired through logging in the OLT management software interface. In this way, only the personnel having the administration priority can login the OLT to acquire the messages about the connection state and the identification of the ONU. However, the common front-line maintenance personnel can only maintain the equipments after acquiring the messages from the personnel having the administration priority. Therefore, not only the maintenance process becomes complicated and inconvenient for being managed, but the disconnection cannot be informed and processed immediately after it occurs. A common ONU at the customer premise only offers indicator display about the basic connection state, instead of offering further identification information for the network administrators' reference. Therefore, when the system has a problem, the difficulty in detection is increased, and thus, it is not a desirable design but needs to be improved.

In order to facilitate the management and maintenance of the PON system after it has been widely applied, in view of the problems to be urgently solved in the above conventional art, the inventor of the present application considers it is necessary to invent a PON equipment capable of detecting the connection state and the LLID conveniently. After exerting great efforts in thinking and researching to make an improvement and innovation, a PON equipment capable of displaying the connection state and the LLID is accomplished.

### SUMMARY OF THE INVENTION

The present invention is directed to a PON equipment capable of displaying a connection state and a logical link identifier (LLID), which aims at utilizing the characteristics of the MPCP and the LLID together with a programmable logic element and a display unit to achieve a PON equipment capable of determining the connection state and identification according to the display unit, so as to solve the problem that PON equipments in the conventional PON system cannot display the connection state and the LLID. In order to achieve the above objective, the present invention provides a PON equipment capable of displaying a connection state and an LLID, in which the PON equipment refers to an OLT and an ONU. The composition structure of the OLT and the ONU and the signal receiving process are further illustrated below.

The OLT is constituted by an optical path, a circuit, an optical transceiver module, a multiplexer/de-multiplexer (Mux/Demux), an OLT system-on-a-chip (SoC), a CPU, a programmable logic element, and a display unit, and determines the connection state and the identification according to the connection state and the LLID. Upon receiving an optical signal through the optical fiber of the optical path, the OLT transmits the optical signal to the optical transceiver module for converting the optical signal into a differential signal. Next, the Mux/Demux de-multiplexes the converted differential signal into an interface signal for being transmitted to the OLT SoC. Then, the OLT SoC converts the interface signal into a packet signal for performing the packet processing. Then, the connection state signal and the LLID signal are obtained during the process of encapsulating/decapsulating the packet, and then, both the two signals are transmitted to the CPU for being encoded. Then, a plurality of corresponding state signals is outputted to the programmable logic element, and the programmable logic element decodes and performs a logical calculation on the received state signals and generates corresponding trigger signals for triggering the display unit, so as to achieve the efficacy that the OLT is capable of displaying the connection state and the LLID.

The ONU is constituted by an optical path, a circuit, an optical transceiver module, an ONU SoC, a CPU, a programmable logic element, and a display unit, and determines the identification according to the LLID signal. The composition structure and the signal processing flow of the ONU are similar to that of the OLT, which thus is not repeated herein in detail, but only the differences there-between are illustrated below. In terms of the element composition, the ONU optical transceiver module adopts a laser at a lower cost having a wavelength of 1.3 μm to reduce the cost of the customer premise equipment. Moreover, the ONU SoC is integrated with the Mux/Demux, which simplifies the hardware architecture of the ONU. Therefore, during the process of receiving the signals, the optical transceiver module directly transmits the converted differential signal to the ONU SoC, and then, the Mux/Demux in the ONU SoC converts the differential signal into an interface signal.

In a preferred embodiment of the present invention, the programmable logic element is a complex programmable logic element, the display unit of the OLT is constituted by a matrix LED or an LCD, and the display unit of the ONU is constituted by at least one LED.

In a point to multi-point (P2MP) network architecture, once being disposed with the PON equipment of the present invention, the OLT at the central office acquires the connection state and the identification of the optical communication equipment, and the ONU at the customer premise displays the LLID of itself, so as to offer the identification information required by the network administrators at the central office to eliminate the network errors. If an error occurs to the ONU connection, the network administrator at the central office can observe the connection state provided by the connected OLT display unit according to the ONU identification information provided by the user, so as to further determine the exact problem.

In order to make the present invention be further comprehensible, the present invention is illustrated below in great detail with reference to the accompanying drawings.

### BRIEF DESCRIPTION OF THE DRAWINGS

FIG. 1 is a topology map of a point to multi-point (P2MP) network entity in a PON system.

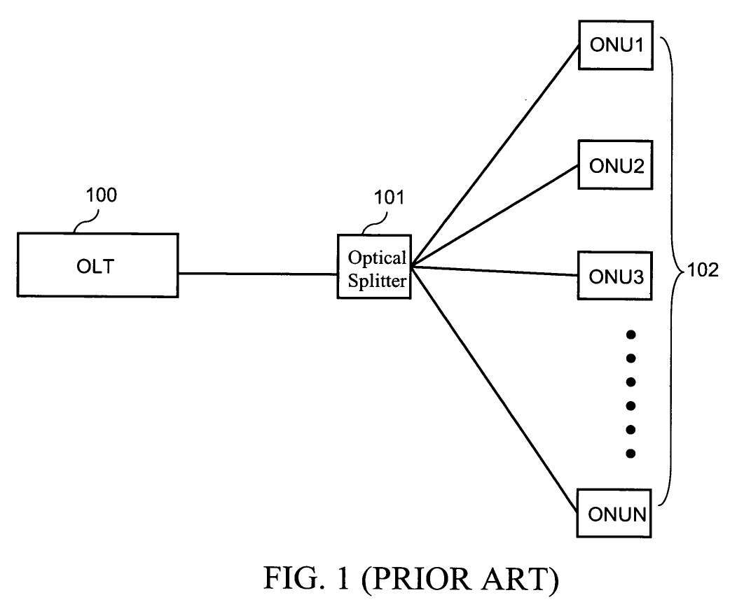

FIG. 2 is a schematic view of a P2MP network packet transmission in the PON system.

FIG. 3 is a schematic view of packet transmission between ONUs in the PON system.

FIG. 4 is a schematic view of an automatic ONU discovery program in the PON system.

FIG. 5 is a block diagram of a PON equipment applied in the OLT according to the present invention.

FIG. 6 is a block diagram of the PON equipment applied in the ONU according to the present invention.

FIG. 7 is a schematic view of a display mode of the PON equipment applied in the OLT according to an embodiment of the present invention.

FIG. 8 is a schematic view of a display mode of the PON equipment applied in the ONU according to an embodiment of the present invention.

FIG. 9 is a schematic view of a display mode of the PON equipment applied in the OLT and the ONU according to an embodiment of the present invention.

### DETAILED DESCRIPTION OF THE INVENTION

The present invention is mainly directed to a PON equipment capable of displaying a connection state and a logical link identifier (LLID). As described above, the PON system is substantially a topology in a P2MP form, and hereinafter, the role that the LLID plays in the packet transmission process in the PON system is illustrated with reference to the drawings, and how the ONU acquires the LLID assigned by the OLT through the MPCP is illustrated in brief.

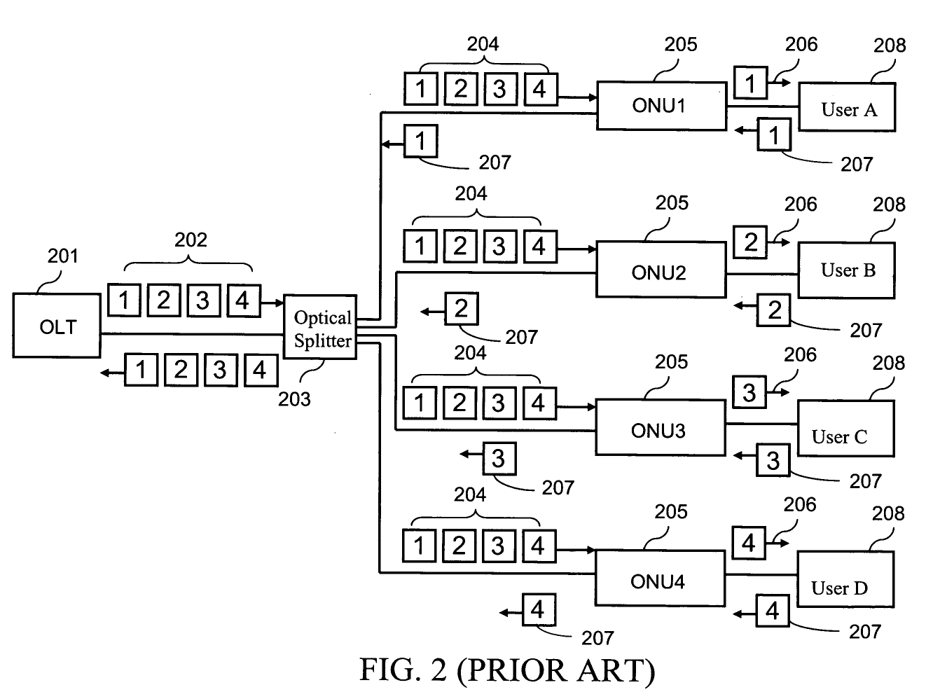

First, the packet transmission process in the PON system is illustrated with reference to FIG. 2, in which a central office equipment OLT 201, an optical splitter 203, four customer premise equipments ONU 205, and four users 208 together constitute a typical PON system. The users 208 represent devices connected with the ONU, such as computers and handheld personal digital assistants (PDAs). Since the PON is a topology in the form of P2MP, the OLT transmits downlink packets to each user by means of broadcasting. When the OLT 201 transmits the downlink packets 202 to pass through the optical splitter 203, the optical signal is split into multiple downlink packets 204 for being transmitted to all the ONUs 205. Each ONU 205 identifies whether a downlink packet is its own downlink packet or not according to the LLID in the multiple downlink packet 204, then, only receives its own downlink packet 206, and then transmits its own downlink packet 206 to each user 208. The LLID is assigned by the OLT 201 when the ONU 205 is added into the PON. When each user 208 uploads data to the OLT 201 through the ONU 205, uplink packets 207 of each user are gathered to the same optical fiber, such that the process of time-division multiplexing (TDM) or wavelength division multiplexing (WDM) is used for transmission, and thus avoiding the collision between multiple uplink packets 207.

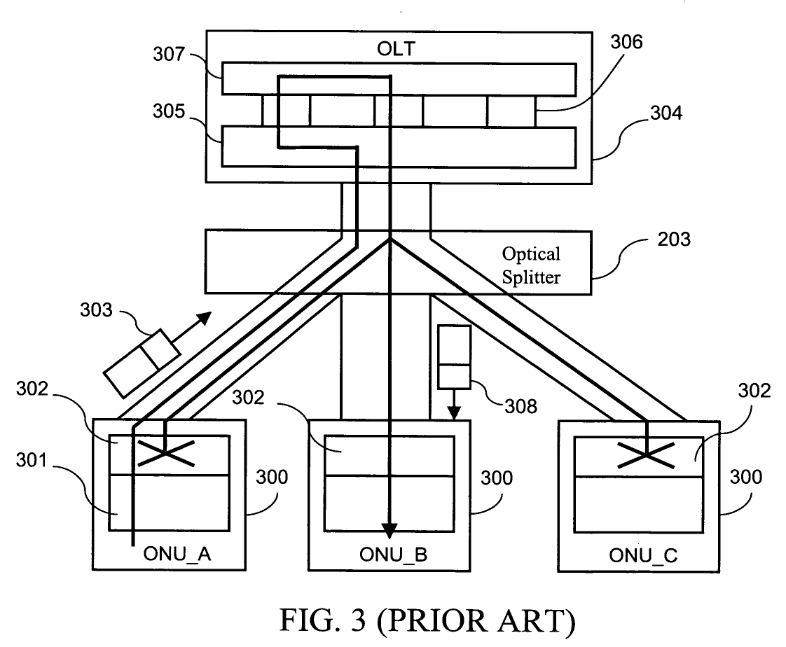

After the packet transmission process between the OLT and the ONU has been illustrated, the packet transmission process between the ONUs in the PON system is illustrated below with reference to FIG. 3. As known from FIG. 3 that, the PON system is constituted by a central office equipment OLT 304, an optical splitter 203, and three customer premise equipments ONUs 300. The ONU 300 includes a MAC port 301 and a P2P simulator 302; and the OLT 304 includes a P2P simulator 305, three MAC ports 306 corresponding to the ONUs 300, and an Ethernet bridge 307. When the ONU_A 300 intends to transmit a packet to the ONU_B 300, after being marked with a port number and an LLID through the MAC port 301 and the P2P simulator 302, the data is encapsulated into a packet 303 for being transmitted through the optical fiber. Then, the packet 303 is transmitted into the P2P simulator 305 of the OLT 304 via the optical splitter 203, in which the LLID is resolved, and then transmitted to a corresponding MAC port 306. Then, the packet is transferred by the Ethernet bridge 307 to the MAC port 306 in the OLT corresponding to the ONU_B300, and marked with a port number of the ONU_B. Then, the packet is marked with the LLID of the ONU_B 300 through the P2P simulator, and finally, the packet 308 is sent out by means of broadcasting. After the P2P simulators 302 of the ONU_A 300 and the ONU_C 300 receive the packet 308, the LLID is determined, and then the unmatchable packet 308 is dropped.

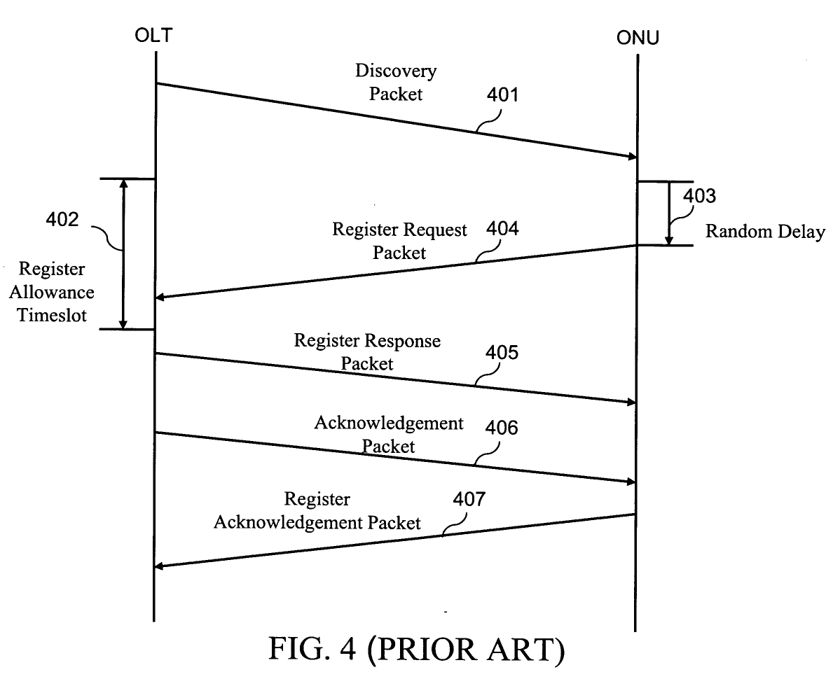

As known from the above two packet transmission processes, the LLID plays a role of identification in the P2P simulation in the P2MP topology architecture. The LLID in the PON is assigned by the OLT at the central office, and is informed to the ONU of the customer premise according to the MPCP. Therefore, the way that the ONU acquires the LLID assigned by the OLT through the MPCP is illustrated through the ONU automatic discovery program in the PON system with reference to FIG. 4. The ONU automatic discovery program achieves the automatic discovery of the ONU through the MPCP communication protocol based upon the IEEE802.3ah standard. As known from FIG. 4 that, the whole ONU automatic discovery program includes packet transmission process such as a discovery packet 401, register allowance timeslot 402, a random delay 403, a register request packet 404, a register response packet 405, an acknowledgement packet 406, and a register acknowledgement packet 407. First, an OLT broadcasts the discovery packet 401 including an OLT register allowance timeslot 402 for informing the newly-added ONU about when to register. After the newly-added ONU has received the information and entered the register allowance timeslot 402, in order to avoid the collision caused by the simultaneous registration of multiple newly-added ONUs, a period of random delay 403 is required, and after the random delay 403, the register request packet 404 is sent out to make registration to the OLT. Upon receiving the register request packet 404 in the register allowance timeslot 402, the OLT sends the register response packet 405 including the LLID assigned to the ONU to the ONU, then the OLT sends a standard acknowledgement packet 406, and finally, the ONU returns the register acknowledgement packet 407 to the OLT, so as to accomplish the automatic discovery of the ONU.

In view of the disadvantages commonly existed for the PON equipments in the conventional PON system, once the customer premise feedbacks that an interruption of the network connection occurs, the network administrators at the central office must login the connected OLT administration interface to acquire the connection state of the customer premise, so as to make further processing.

Therefore, the present invention provides a PON equipment capable of displaying connection state and LLID, which is provided for the network administrator to acquire the state of the customer premise through the display unit of the OLT, so as to avoid the complicated process of logging in the administration interface. Furthermore, a common user can also acquire the LLID obtained by the OLT through the display unit of the ONU, so as to offer the required identification information to the network administrator.

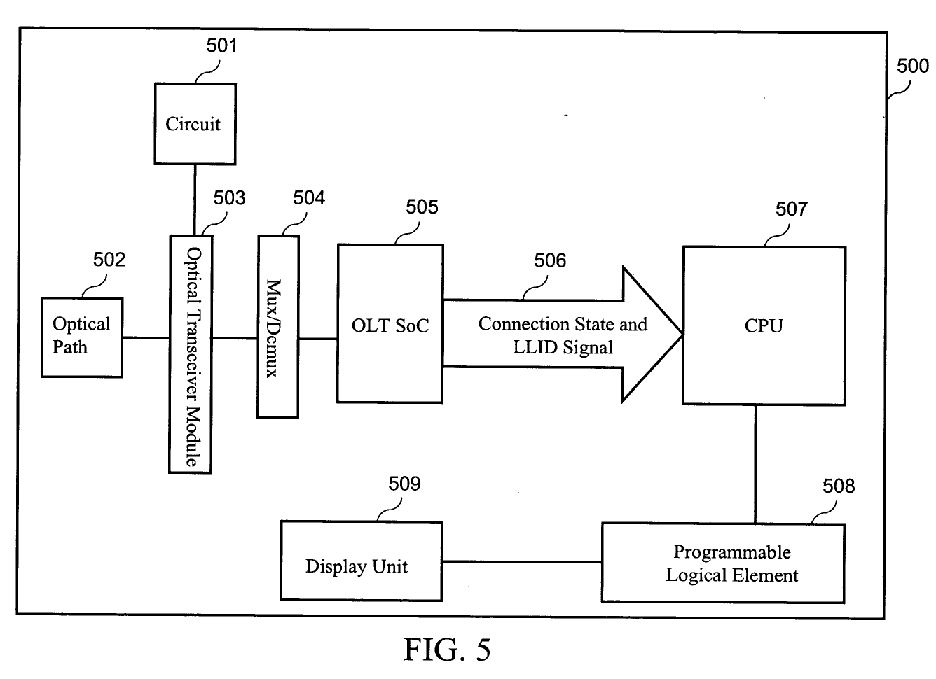

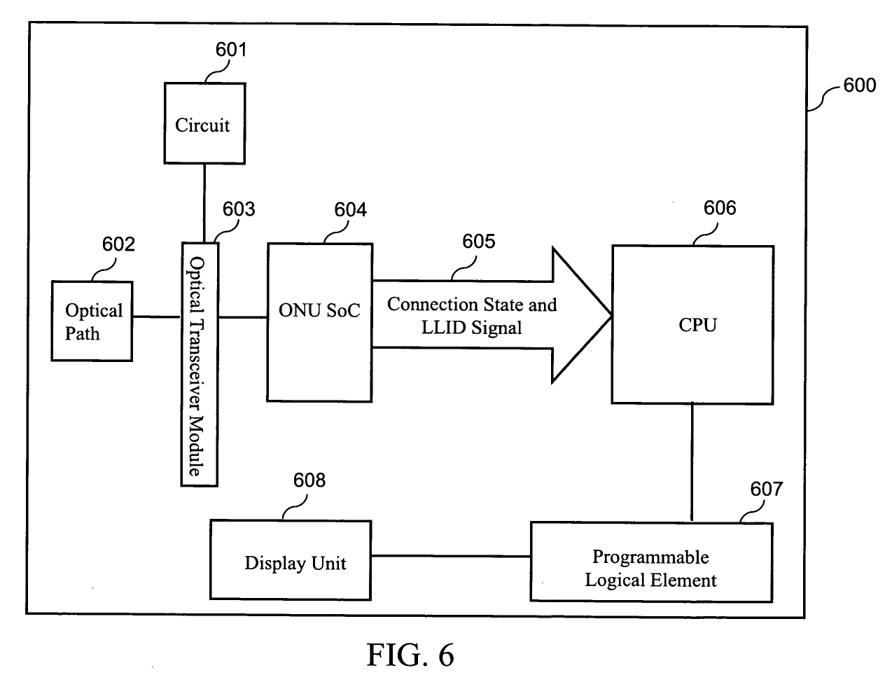

FIGS. 5 and 6 show a PON equipment capable of displaying connection state and LLID. FIG. 5 is a block diagram of a PON equipment applied in an OLT 500, which is constituted by a circuit 501, an optical path 502, an optical transceiver module 503, a multiplexer/de-multiplexer (Mux/Demux) 504, an OLT system-on-a-chip (SoC) 505, a CPU 507, a programmable logic element 508, and a display unit 509. The optical transceiver module 503 is used to perform a conversion between an optical signal and a differential signal. The Mux/Demux 504 is used to perform a conversion between the differential signal and an interface signal. The interface signal can be ten bit interface (TBI), a Gigabit media independent interface (GMII), a reduced ten bit interface (RTBI), or a reduced Gigabit media independent interface (RGMII). The OLT SoC 505 compliant with the IEEE 802.3ah standard is used to perform media access control (MAC), dynamic bandwidth allocation (DBA), operations, administration and maintenance (OAM), and security for the PON system. The OLT SoC 505 is used to perform a conversion between the interface signal and a packet signal and encapsulate/decapsulate the packet, and acquire the connection state signal and the LLID signal during the process of encapsulating/decapsulating the packet. The CPU 507 is used to receive the connection state signal and the LLID signal 506 transmitted from the OLT SoC 505, and output a plurality of corresponding state signals after an encoding process. The programmable logic element 508 is a complex programmable logic element. The programmable logic element 508 is used to receive the plurality of state signals, and decode and perform a logical calculation on the state signals to generate corresponding trigger signals. The display unit 509 is a liquid crystal display (LCD) or at least a light emitting diode (LED). The display unit 509 is used to receive the corresponding trigger signals for triggering the display unit 509 to display the connection state and the LLID of the PON equipment. In the OLT 500, the display unit 509 displays the connection states and LLIDs of the 32 ONUs by using indicators of different colors and bright/dark states of 4×8 matrix LED.

As shown in FIG. 5, the OLT 500 receives the optical signal transmitted from the optical fiber through the optical path 502. After entering an amplifier, a filter, and a decoder in the optical transceiver module 503, the optical signal becomes a differential electrical signal, and then, the differential electrical signal is converted into a ten bit interface (TBI) signal or a Gigabit media independent interface (GMII) signal through the Mux/Demux 504, and then transmitted to the OLT SoC 505 compliant with the IEEE802.3ah standard. The OLT SoC 505 is responsible for processing the MPCP protocol and transmitting the connection state and the LLID signal 506 to the CPU 507. After receiving and encoding the connection state and the LLID signal 506 transmitted from the OLT SoC 505, the CPU 507 transmits a plurality of state signals to the programmable logic element 508. Then, the programmable logic element 508 receives the state signals outputted from the CPU 507, and decodes and performs a logical calculation on the state signals, and then outputs the result to the display unit 509. Finally, the display unit 509 displays the connection state and the identification according to the signal outputted after the decoding and logical calculation process of the programmable logic element 508.

FIG. 6 is a block diagram of a PON equipment applied in an ONU 600, which is constituted by a circuit 602, an optical path 601, an optical transceiver module 603, an ONU system-on-a-chip (SoC) 604, a CPU 606, a programmable logic element 607, and a display unit 608. The function of each element for the ONU is similar to that of the above OLT, which thus is not repeated in detail, but only the difference is illustrated. In the ONU 600, the ONU SoC 604 is integrated with the Mux/Demux, such that the ONU SoC 604 is used to perform a conversion between a differential signal and an interface signal and encapsulate/decapsulate the packet, and after the LLID is acquired during the process of encapsulating/decapsulating the packet, the LLID signal 605 is transmitted to the CPU 606. Furthermore, the display unit 608 is an LED row constituted by five LEDs, which shows 32 LLID changes by utilizing the on/off state of indicators.

After being transmitted to the optical transceiver module 603 through the optical path 602, the optical signal enters the amplifier, the filter, and the decoder in the optical transceiver module 603 and becomes a differential electrical signal. Then, the differential electrical signal is transmitted to the ONU SoC 604 compliant with IEEE802.3ah standard, for being converted into a TBI or a GMII signal through the Mux/Demux in the ONU SoC 604, and then, the differential electrical signal is transmitted to a media access controller responsible for processing the MPCP and transmitting the LLID signal 605 to the CPU 606. After receiving and encoding the LLID signal 605 transmitted from the ONU SoC 604, the CPU 606 transmits a plurality of state signals to the programmable logic element 607. Then, the programmable logic element 607 receives the state signals outputted by the CPU 606, and decodes and performs a logical calculation on the state signals and outputs the result to the display unit 608. Finally, the display unit 608 displays the identification according to the signal outputted after the decoding and logical calculation process of the programmable logic element 607.

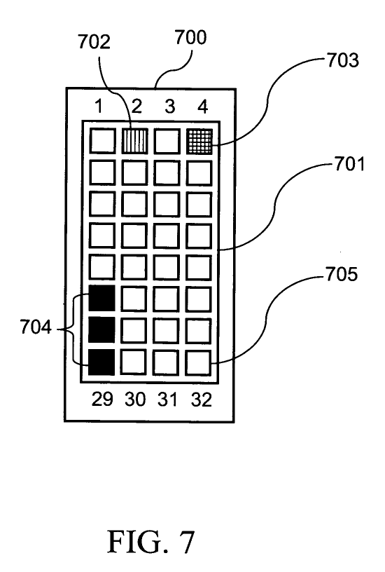

FIG. 7 shows a display mode of the PON equipment at the OLT of the present invention. In order to easily demonstrate, we use a configuration of different mesh points in FIG. 7 to indicate the LEDs of different colors and states, in which the display unit of the OLT 700 at the central office is a matrix LED 701. The matrix LED 701 has totally 32 LEDs marked with numbers 1-32 from left to right and from top to bottom respectively, and each LED represents a corresponding ONU. Therefore, each OLT 700 can at least represent ONU states of 32 customer premises. However, this is only one embodiment, and actually different designs can be made according to different requirements, in which the green LED 708 represents a normal connection, the blinking green LED 708 represents that the packet is being transmitted, the red LED 704 represents no connection or connection failure, the dark LEDs 705 represents no connection assignation. The bright red LEDs 704 of Number 21, Number 25, and Number 29 represent connection failure for the ONUs of the three numbers.

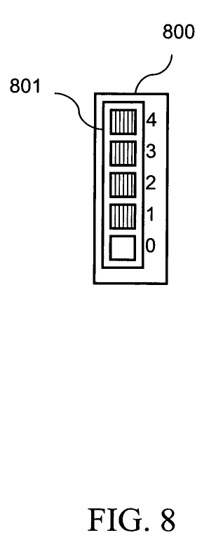

FIG. 8 shows a display mode of the PON equipment at the ONU of the present invention. The display unit of the ONU 800 at the customer premise is constituted by five LEDs 801, marked with Number 4, Number 3, Number 2, Number 1, and Number 0 sequentially from top to bottom, which respectively represent 4^{th} power of 2, 3^{rd} power of 2, 2^{nd} power of 2, 1^{st} power of 2, and 0^{th} power of 2, so as to display 32 types of LLIDs.

As shown in FIG. 8, for example, if the LEDs of Number 4, Number 3, Number 2, and Number 1 are in a bright state at the same time, it represents a sum of 4^{th} power of 2, 3^{rd} power of 2, 2^{nd} power of 2, 1^{st} power of 2, and 0^{th} power of 2, so that the LLID of the ONU is 31, and thus, the user can easily determine the identification of the ONU 800.

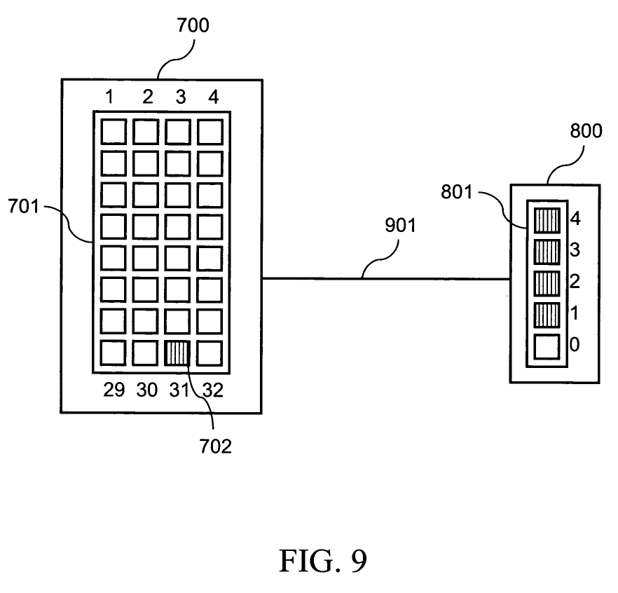

Hereinafter, an embodiment is given below to illustrate the display mode for the PON equipment of the present invention. Referring to FIGS. 4, 5, 6, and 9, when being added into the optical fiber network topology, the ONU 800 receives a discovery packet 401 transmitted from the OLT 700 by broadcasting through the optical fiber 901. The discovery packet 401 enters the optical transceiver module 603 through the ONU optical path 602 connected with the optical fiber 901, for being converted into a differential electrical signal. Then, the ONU SoC 604 receives the differential signal, and then, sends the register request packet 404 according to the register allowance timeslot 402 message in the received discovery packet 401, after entering the register allowance timeslot 402 and after a period of random delay 403.

The register request packet 404 is transmitted to the optical path 502 of the OLT through the optical fiber 901 and entered the optical transceiver module 503 for being converted into a differential signal. The Mux/Demux 504 receives the differential signal and converts the differential signal into a TBI or a GMII signal. The OLT SoC 505 receives a network protocol of MPCP for processing the TBI or GMII signals, and allocates an LLID of Number 31 corresponding to the ONU, adds the LLID of Number 31 into the register response packet 405 for being transmitted to the ONU, and displays that the green LED 703 is blinked in the LED of Number 31 of the matrix LED 701. After the register response packet 405 has been transmitted, a period of time is delayed and then, the OLT transmits the acknowledgement packet 406.

After the ONU receives the register response packet 405 transmitted from the OLT 700 through the optical fiber 901, the LLID is extracted from the packet in a P2P simulator of the ONU SoC 604, and after acquiring that the LLID is corresponding to Number 31, an LLID signal 605 is outputted, and then, the register acknowledgement packet 407 is transmitted to the OLT. After the CPU 606 receives the LLID outputted from the ONU SoC 604, it outputs a plurality of state signals after a decoding process. After receiving the state signals outputted from the CPU 606, the programmable logic element 607 decodes and performs a logical calculation on the state signals to generate at least one trigger signal. The display unit 608 receives the trigger signal for triggering the LEDs of Number 4, Number 3, Number 2, and Number 1.

After the OLT receives the register acknowledgement packet 407, the LED of Number 31 of the matrix LED 701 changes from the blinking green LED 703 into the green LED 702. If the MPCP handshaking process fails, the LED of Number 31 of the matrix LED 701 changes from the blinking green LED 703 into the red LED 704.

Therefore, once the user at the customer premise found that a connection interruption occurs, the message displayed by the display unit 801 of the ONU 800 is informed to the network administrator at the central office. Upon acquiring the LLID fed back from the customer premise, the network administrator can know that a connection failure occurs to the current customer premise of Number 31, instead of no connection.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A PON equipment capable of displaying a connection state and a logical link identifier (LLID), applicable for receiving an optical signal from more than one ONU of a PON system, the PON equipment at least comprising:
an optical transceiver module, for performing a conversion between the optical signal and a differential signal;
a multiplexer/de-multiplexer (Mux/Demux), for performing a conversion between the differential signal and an interface signal;
an OLT system-on-a-chip (SoC), for performing a conversion between the interface signal and a packet signal and encapsulating/decapsulating the packet, and acquiring a connection state signal and a LLID signal during the process of encapsulating/decapsulating the packet;
a central processing unit (CPU), for receiving the connection state signal and the LLID signal transmitted from the OLT SoC, and outputting a plurality of corresponding state signals after an encoding process;
a programmable logic element, for receiving the plurality of corresponding state signals, and decoding and performing a logical calculation on the state signals to generate at least one corresponding trigger signal; and
a display unit, for receiving the at least one trigger signal, and triggering the display unit to display the connection state and the LLID of the PON equipment;
wherein a handshaking communication process is conducted between the PON equipment and the ONUs through a multi-point control protocol (MPCP).

2. The PON equipment capable of displaying the connection state and the LLID as claimed in claim 1, wherein the interface signal has a signal format of a ten bit interface (TBI), a Gigabit media independent interface (GMII), a reduced ten bit interface (RTBI), or a reduced Gigabit media independent interface (RGMII).

3. The PON equipment capable of displaying the connection state and the LLID as claimed in claim 1, wherein the OLT SoC compliant with the IEEE 802.3ah standard is used to perform media access control (MAC), dynamic bandwidth allocation (DBA), operations, administration and maintenance (OAM), and security for the PON system.

4. The PON equipment capable of displaying the connection state and the LLID as claimed in claim 1, wherein the connection state signal is in a state generated after the handshaking communication process has been performed between the ONUs and the PON system through the MPCP.

5. The PON equipment capable of displaying the connection state and the LLID as claimed in claim 1, wherein the LLID is an identifier assigned by the PON equipment after the ONUs have been added into the PON system.

6. The PON equipment capable of displaying the connection state and the LLID as claimed in claim 1, wherein the programmable logic element is a complex programmable logic element.

7. The PON equipment capable of displaying the connection state and the LLID as claimed in claim 1, wherein the display unit is a liquid crystal display (LCD) or at least a light emitting diode (LED).

8. The PON equipment capable of displaying the connection state and the LLID as claimed in claim 1, wherein the PON equipment is an OLT.

9. A PON equipment capable of displaying a connection state and a logical link identifier (LLID), applicable for receiving an optical signal from an ONU of a PON system, the PON equipment at least comprising:
an optical transceiver module, for performing a conversion between the optical signal and a differential signal;
an ONU system-on-a-chip (SoC), for performing a conversion between the differential signal and an interface signal and encapsulating/decapsulating a packet, and acquiring an LLID signal during the process of encapsulating/decapsulating the packet;
a CPU, for receiving the LLID signal transmitted from the ONU SoC, and outputting a plurality of corresponding state signals after an encoding process;
a programmable logic element, for receiving the plurality of corresponding state signals, and decoding and performing a logical calculation on the state signals to generate at least one corresponding trigger signal; and
a display unit, for receiving the at least one trigger signal, such that the display unit is triggered to display the connection state and the LLID for the PON equipment;
wherein a handshaking communication process is conducted between the PON equipment and the OLT through an MPCP.

10. The PON equipment capable of displaying the connection state and the LLID as claimed in claim 9, wherein the ONU SoC compliant with MAC and MPCP of the IEEE802.3ah standard is used to communicate with the OLT.

11. The PON equipment capable of displaying the connection state and the LLID as claimed in claim 9, wherein the LLID is an identifier assigned by the OLT after the PON equipment has been added into the PON system.

12. The PON equipment capable of displaying the connection state and the LLID as claimed in claim 9, wherein the programmable logic element is a complex programmable logic element.

13. The PON equipment capable of displaying the connection state and the LLID as claimed in claim 9, wherein the display unit is an LCD or at least an LED.

14. The PON equipment capable of displaying the connection state and the LLID as claimed in claim 9, wherein the PON equipment is an ONU.
